(19) United States
(12) Patent Application Publication
(10) Pub. No.: US 2009/0301637 A1
(43) Pub. Date: Dec. 10, 2009

(54) SPACER ASSEMBLY FOR INSULATING GLAZING UNIT AND METHOD FOR ASSEMBLING AN INSULATING GLAZING UNIT

(76) Inventor: Gerhard Reichert, New Philadelphia, OH (US)

Correspondence Address: FRED ZOLLINGER III, P.O. BOX 2368, NORTH CANTON, OH, 44720, US

(21) Appl. No.: 12/478,805

(22) Filed: Jun. 5, 2009

Related U.S. Application Data
(63) Continuation of application No. 09/670,705, filed on Sep. 27, 2000, now abandoned.

(51) Int. Cl. E06B 3/24

(52) U.S. Cl. 156/109

(57) ABSTRACT

The glazing unit of the present invention is hermetically sealed with a primary sealant and then sealed with a secondary sealant that may provide structural support to the glazing unit. The primary sealant is applied hot to both the spacer and glazing sheets simultaneously and is applied after the spacer is initially attached to the glazing sheets so that the sealant is not disturbed after it is applied. The sealants are preferably applied with robotic sealing nozzles on an assembly line. In one embodiment, the sealants are consecutively applied by first and second application nozzles that move in concert around the perimeter of the glazing unit.

### BACKGROUND OF THE INVENTION

1. Technical Field

The present invention generally relates to insulating glazing units and methods for assembling and sealing insulating glazing units. More particularly, the present invention relates to a spacer assembly for an insulating glazing unit and to methods for creating the spacer assembly. Specifically, the present invention relates to a spacer assembly and a method for fabricating a spacer assembly having a primary sealant that hermetically seals the glazing unit and a secondary structural sealant that is applied over the primary sealant.

2. Background Information

Insulating glazing units are known in the art as energy-saving devices that include at least a pair of glass sheets separated by a spacer assembly. The chamber between the glass sheets includes an insulating body of gas (such as air or an inert gas) that slows the transfer of energy through the glazing unit.

Numerous spacer assemblies for insulating glazing units are known in the art. These spacer assemblies have a variety of different configurations and are fabricated from different materials. One type of known spacer assembly includes a hollow spacer tube that includes opposed glazing sheet-engaging surfaces. The spacer tubes are formed into frames sized to fit the glazing unit. A sealant is applied around the frame on two or three sides of the spacer by manually cartwheeling the frame through a sealant extruder.

A problem with this method is that the handling of the sealant-laden spacer frame can damage the sealant by reducing the thickness of the sealant at locations along the frame and can introduce contaminants into the sealant. The sealant-laden frames are attached to opposed glazing sheets to form a glazing unit. The glazing unit is sealed by passing the glazing unit through a heated roller press that heats the sealant between the spacer and the glass while applying pressure. The heat and the pressure wet the sealant out against the glass and seal the insulating chamber of the glazing unit. Even if the sealant on the spacer has not been damaged during the cartwheeling operation and the placement of the frame on the glazing sheets, the application of the heat and pressure can result in an imperfect seal. The seal may be imperfect because the sealant has been applied to the spacer at one temperature and to the glass at another temperature. In other systems, the sealant is not reheated and is wetted out only by applying pressure. The seal may also be damaged if the sealant has become contaminated with solids or moisture. The seal may also be imperfect because the extruder may extrude a skip in the sealant. A further problem with spacers having pre-applied sealant is that the amount of sealant disposed at the corners of the spacer frame may be insufficient to seal the corners of the glazing units.

Glazing units with imperfect seals must be rejected and scrapped at the cost of the manufacturer. An imperfect seal may also cause the unit to prematurely fail in the field forcing the manufacturer to replace windows at the consumers location. The art thus desires a method for sealing a glazing unit having an open spacer member that avoids the problems in the prior art and results in a better seal and fewer defective glazing units.

Another spacer assembly known in the art includes a structural foam body that spaces the glass sheets. An adhesive holds the foam body to the glass and a sealant is disposed intermediate the foam body and the glass to hermetically seal the insulating chamber of the glazing unit. Although this spacer assembly is an extremely efficient insulator and effectively seals the glazing unit, some applications desire that the outer perimeter of the glazing unit include an additional support that supports the glass sheets. Such structural support is required in glass applications having exposed edges. Exposed edge glass applications do not include sashes between the glass sheets and create an all glass appearance. The art thus desires a method for forming an insulating glazing unit with a spacer that structurally supports the perimeter of the glass sheets.

### SUMMARY OF THE INVENTION

In view of the foregoing, the present invention provides a method for sealing an insulating glazing wherein the primary sealant is applied to the glass and spacer simultaneously so that the sealant does not have to be handled during the assembly of the glazing unit.

An aspect of the invention is to provide a method for fabricating a spacer for an insulating glazing unit wherein primary and secondary sealants are applied to the spacer in consecutive application processes.

An aspect of the invention is to provide a method for fabricating a spacer for an insulating glazing unit wherein the primary sealant that hermetically seals the insulating chamber is applied to the spacer with a secondary sealant being applied over the primary sealant.

An aspect of the invention is to provide a spacer assembly for an insulating glazing unit wherein a spacer is connected to first and second glass sheets by a first adhesive, sealed with a hot-applied adhesive, and structurally supported by a structural sealant.

An aspect of the invention is to provide a spacer assembly having a secondary structural sealant that protects the hermetic sealant.

An aspect of the invention is to provide a spacer wherein the sealant is applied intermediate the glass and the spacer at the same temperature and pressure.

An aspect of the invention is the hot applied sealant flashes away moisture and wets out against the glass better than a cold applied sealant that is wetted out by using a roller press.

An aspect of the invention is to provide a spacer that is hermetically sealed with a primary sealant that is not pre-applied so that the spacer is easy to bend into the correct shape before being applied to the glass.

The invention provides a method for fabricating an insulating grazing unit comprising the steps of providing a first glazing sheet having a first perimeter; connecting a spacer to the first glazing sheet at a location spaced inwardly from the first perimeter; providing a second glazing sheet having a second perimeter; connecting the second glazing sheet to the spacer such that the spacer is disposed at a location inward from the second perimeter whereby an outwardly-facing channel is formed between the glazing sheets and the spacer and an insulating chamber is formed inward of the spacer between the glazing sheets; hermetically sealing the insulating chamber by applying a primary sealant into the outwardly-facing channel; and applying a secondary sealant into the outwardly-facing channel after at least a portion of the primary sealant is applied.

The invention also provides method for sealing an insulating glazing unit having first and second glazing sheets spaced apart by a spacer disposed inward of the perimeters of the glazing sheets to form an outwardly-facing channel; the insulating glazing unit having an insulating chamber disposed inward of the spacer between the glazing sheets; the method comprising the steps of hermetically sealing the insulating chamber by applying a primary sealant to at least the corners of the channel disposed adjacent the spacer and glazing sheets; and applying a secondary sealant in the outwardly-facing channel over the primary sealant; the secondary sealant being different from the primary sealant.

The invention further provides a method of forming an insulating glazing unit comprising the steps of providing a first glazing sheet having a first perimeter; connecting a metal spacer to the first glazing sheet at a location spaced inwardly from the first perimeter; providing a second glazing sheet having a second perimeter; connecting the second glazing sheet to the spacer such that the spacer is disposed at a location inwardly from the second perimeter whereby an outwardly-facing channel is formed between the glazing sheets and the spacer and an insulating chamber is formed inwardly of the spacer between the glazing sheets; applying a primary sealant into the outwardly-facing channel to hermetically seal the insulating chamber; and applying a secondary sealant over the primary sealant.

### BRIEF DESCRIPTION OF THE DRAWINGS

The preferred embodiment of the invention, illustrative of the best mode in which applicant contemplated applying the principles of the invention, are set forth in the following description and are shown in the drawings and are particularly and distinctly pointed out and set forth in the appended Claims.

FIG. 1 is a front view of an insulating glazing unit having the spacer assembly installed with the method of the invention.

FIGS. 2A-2J are sectional views of different embodiments of the invention taken along line 2-2 of FIG. 1.

FIG. 2A depicts a first spacer assembly embodiment wherein the primary sealant extends between the glazing sheets.

FIG. 2B depicts a second spacer assembly embodiment wherein the primary sealant is disposed in the corners of the spacer.

FIG. 2C depicts a third spacer assembly embodiment wherein the primary sealant extends between the glazing sheets.

FIG. 2D depicts a fourth spacer assembly embodiment wherein the primary sealant is disposed in the corners of the spacer.

FIG. 2E depicts a fifth spacer assembly embodiment wherein the primary sealant extends between the glazing sheets.

FIG. 2F depicts a sixth spacer assembly embodiment wherein the primary sealant is disposed in the corners of the spacer.

FIG. 2G depicts a seventh spacer assembly embodiment wherein the primary sealant extends between the glazing sheets.

FIG. 2H depicts a eighth spacer assembly embodiment wherein the primary sealant is disposed in the corners of the spacer.

FIG. 2I depicts a ninth spacer assembly embodiment wherein the primary sealant extends between the glazing sheets.

FIG. 2J depicts a tenth spacer assembly embodiment wherein the primary sealant is disposed in the corners of the spacer.

FIG. 3A is a sectional view of an initial step of the method of the invention where the spacer is first connected to one glazing sheet.

FIG. 3B is a sectional view of a step in the process where the second glazing sheet is connected to the spacer.

FIG. 3C1 is a sectional view of a step in the process where the insulating chamber of the glazing unit is hermetically sealed with a primary sealant that extends across the rear of the spacer.

FIG. 3C2 is a sectional view of a step in the process where the insulating chamber of the glazing unit is hermetically sealed with a primary sealant that is disposed only in the corners of the channel.

FIG. 3D is a side view of a step in the process wherein the secondary sealant is applied over the primary sealant.

FIG. 4 is a schematic view of a portion of an assembly line showing first and second sealant application stations.

FIGS. 4A through 4J show the primary sealant being applied at the first sealant application station.

FIG. 5 is a schematic view of a portion of an assembly line showing a single sealant application station.

FIGS. 5A through 5I show the primary and secondary sealants being applied at the sealant application station of FIG. 5.

FIG. 6 is a schematic view of a portion of an assembly line showing first and second sealant application stations.

FIGS. 6A through 6D show the primary and secondary sealants being applied at the first and second sealant application stations.

FIG. 7 is a schematic view of a portion of an assembly line showing first and second sealant application stations.

FIGS. 7A through 7G show the primary sealant being applied at the first sealant application station.

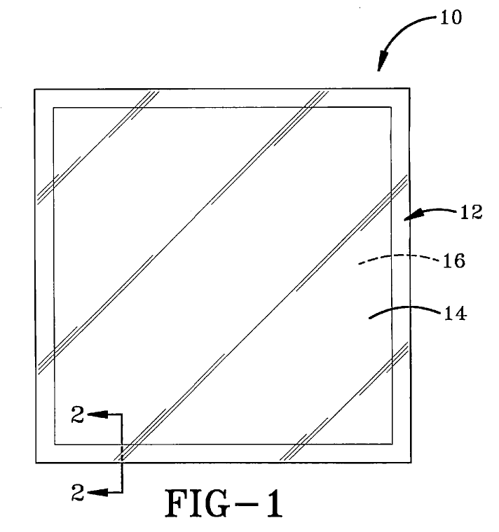

Similar numbers refer to similar elements throughout the specification.

### DESCRIPTION OF THE PREFERRED EMBODIMENTS

An insulating glazing unit 10 includes the spacer assembly 12 of the invention and a pair of glazing sheets 14 and 16. Spacer assembly 12 holds glazing sheets 14 and 16 apart to form an insulating chamber 18. Spacer assembly 12 also hermetically seals chamber 18.

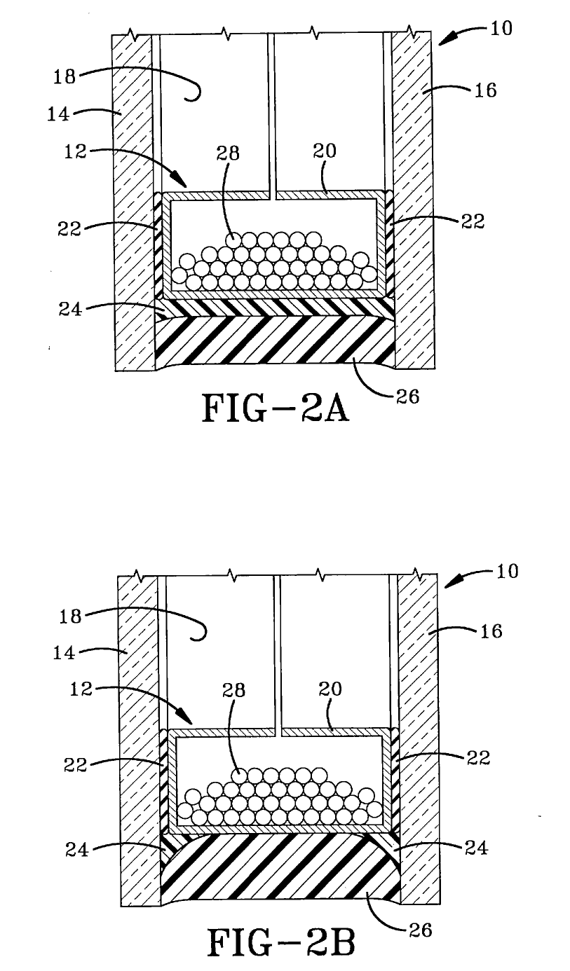

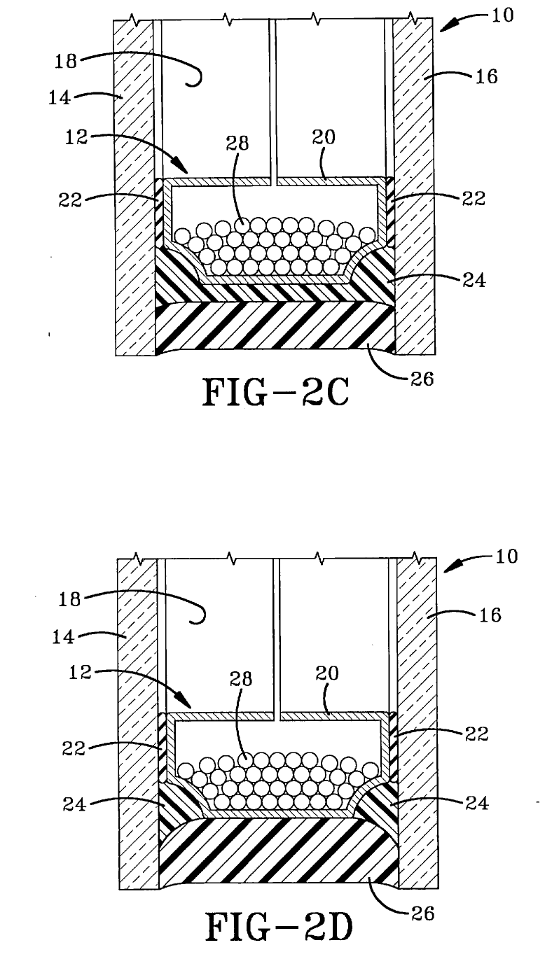

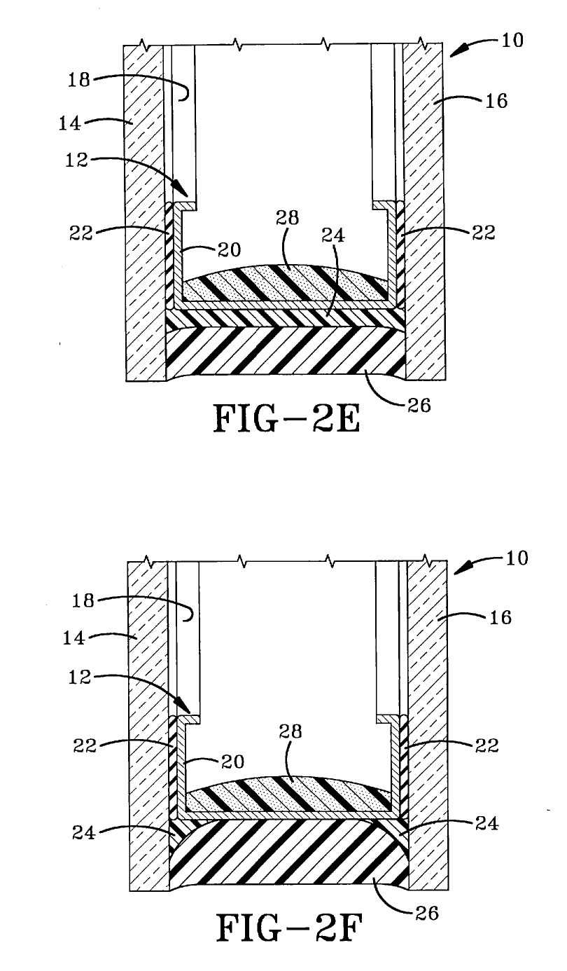

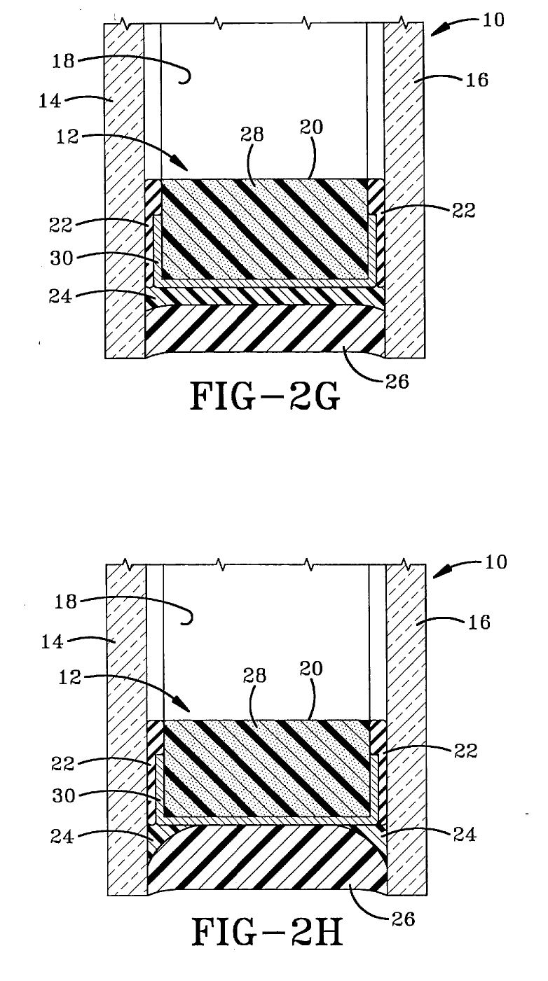

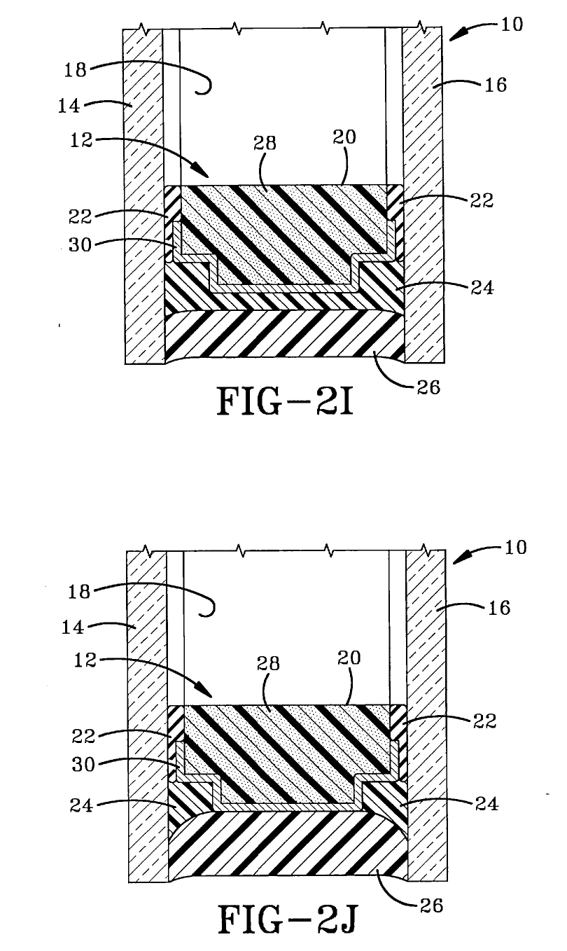

Spacer assembly 12 includes a spacer 20, an adhesive 22, a primary sealant 24, and a secondary sealant 26. In the embodiments of the invention depicted in FIGS. 2A through 2F, spacer 20 is fabricated from a substantially rigid material such as metal or plastic. In some embodiments, the material of spacer 20 will function as a moisture/vapor barrier. In other embodiments, a moisture/vapor barrier layer is connected to or formed with spacer 20 to provide the barrier properties. Unit 10 requires a desiccant 28 to be exposed to chamber 18. Desiccant 28 may be in the form of beads as shown in FIGS. 2A through 2D or in the form of an extruded desiccant matrix as shown in FIGS. 2E and 2J. The desiccant matrix may be applied to the exterior of spacer 20 (FIGS. 2E and 2F) or disposed throughout the body of spacer 20 (FIGS. 2G, 2H, 2I, and 2J).

In the embodiments of the invention depicted in FIGS. 2G through 2I, spacer 20 is a foam body. In these embodiments, a moisture/vapor barrier layer 30 is attached to the outwardly-facing surface of spacer 20 and to the side walls of spacer 20. Barrier layer 30 may be a thin layer of metal, plastic, or the like, or a combination of these materials.

The moisture paths between spacer 20 and sheets 14 and 16 are hermetically sealed by primary sealant 24 to complete the moisture/vapor barrier capability of spacer assembly 12. Primary sealant may be disposed entirely across spacer 20 as shown in FIGS. 2A, 2C, 2E, 2G, and 2I, or may be disposed only in the corners between spacer 20 and sheets 14 and 16 as shown in FIGS. 2B, 2D, 2F, 2H, and 2J. The corners are the areas adjacent both a sheet 14,16 and spacer 20 in the sealant channel 34. The corners may be enlarged by forming spacer 20 with notched corners as shown in FIGS. 2C, 2D, 2I, and 2J.

Secondary sealant 26 is disposed over primary sealant 24 to further seal and support glazing unit 10. In the preferred embodiments of the invention, secondary sealant 26 provides structural support to glazing sheets 14 and 16.

Primary sealant 24 forms a moisture/vapor barrier that hermetically seals insulating chamber 18 from the air surrounding glazing unit 10. Primary sealant 24 is thus one of a variety of sealants that form a long-lasting moisture/vapor seal when applied to a smooth glass surface. One such primary sealant 24 is hot melt butyl. Another primary sealant 24 is polyisobutylene. In other embodiments of the invention, a curable hot melt material may be used as primary sealant 24. Another primary sealant may be a dual seal equivalent. Other primary sealants 24 known to those skilled in the art may also be used to hermetically seal chamber 18.

Secondary sealant 26 is preferably a structural sealant that provides structural support between glazing sheets 14 and 16. Secondary sealant 26 may be a thermoset sealant such as a silicone sealant, a polysulfide sealant, a polyurethane sealant, or the like. Other sealants known to those skilled in the art that cross link to the glass may be used as secondary sealant 26.

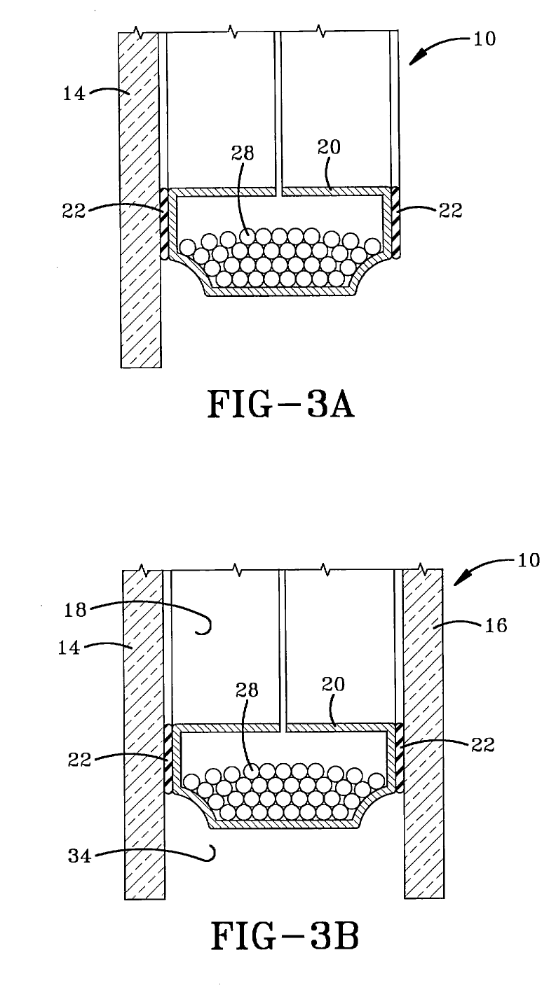

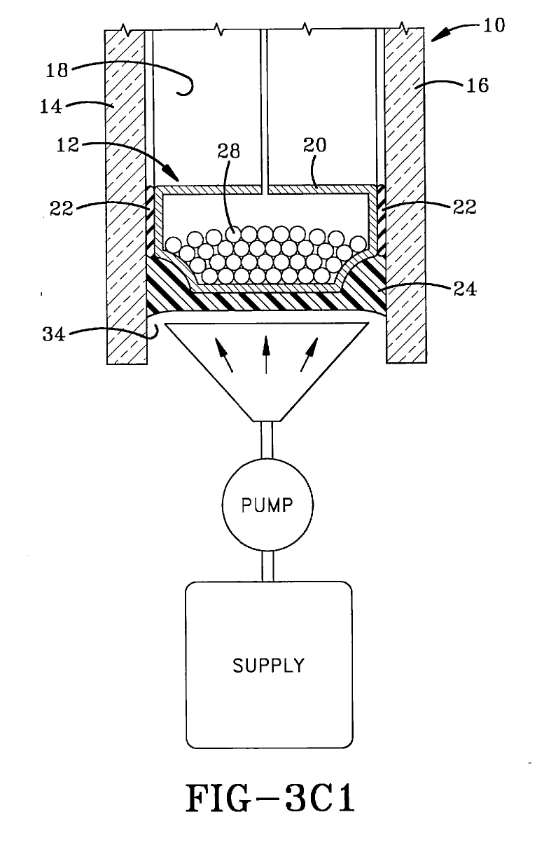

As shown in FIGS. 3A through 3D, glazing unit 10 is assembled by first providing first glazing sheet 14 that has an outer perimeter. Spacer 20 is formed into a frame or applied to first glazing sheet 14 in the form of a frame. Spacer 20 is attached to first glazing sheet 14 with an adhesive 22 at a location disposed inward of the outer perimeter. Spacer 20 may be applied when sheet 14 is disposed vertical or horizontal. Adhesive 22 may be butyl, polyisobutylene, or other substances that at least temporarily hold spacer 20 to glazing sheets 14,16. Second glazing sheet 16 is then placed on spacer 20 so that it is aligned with first glazing sheet 14 to form insulating chamber 18 between sheets 14 and 16 inward of spacer 20 and an outwardly-facing channel 34 between spacer 20 and sheets 14 and 16. Channel 34 is sized and configured to receive both primary and secondary sealants 24 and 26.

FIGS. 3C1 and 3C2 show the application of primary sealant 24 into channel 34. Primary sealant 24 is applied entirely across channel 34 in FIG. 3C1 and only in the notched corners of spacer 20 in FIG. 3C2. In some embodiments, sealant 24 is applied in the corners of channel 34 (FIGS. 2B, 2F, and 2H) without forming the notches at the corners of spacer 20. Primary sealant 24 is applied hot so that it wets out against the glass surfaces and flashes away any residual moisture on the glass. An advantage of the invention is that primary sealant 24 is applied to spacer 20 and glass 14,16 at the same temperature and pressure so that sealant 24 forms the seal between spacer 20 and glass 14,16 at the same time without having to wait to be pressurized and/or reheated at a later time. Another advantage is that primary sealant 24 is not disturbed after it is applied in channel 34. The sealing surfaces of sealant 24 are not exposed so that they do not gather impurities. The invention also protects primary sealant 24 by applying secondary sealant 26 over primary sealant 24 immediately or shortly after primary sealant 24 is applied.

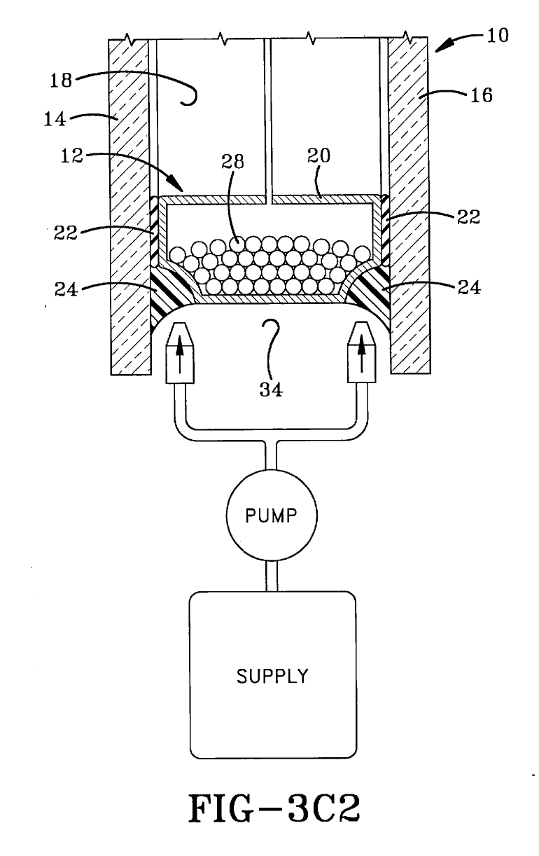

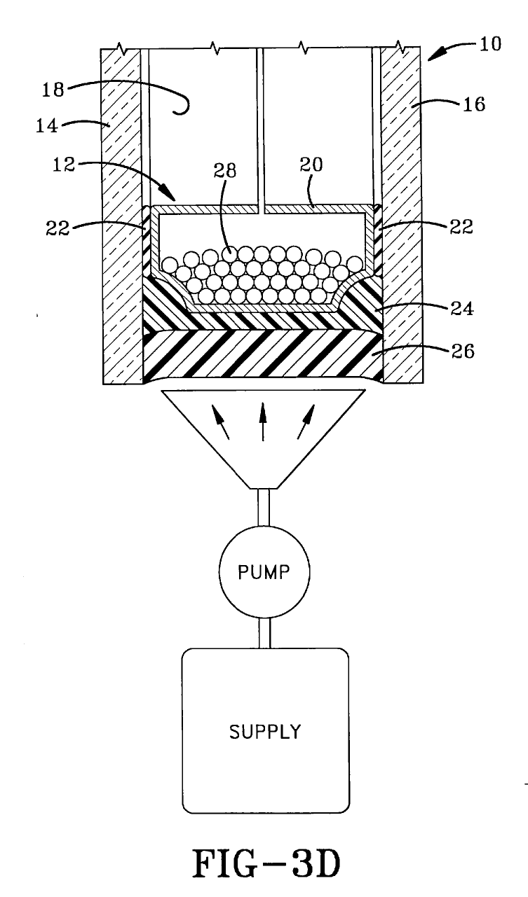

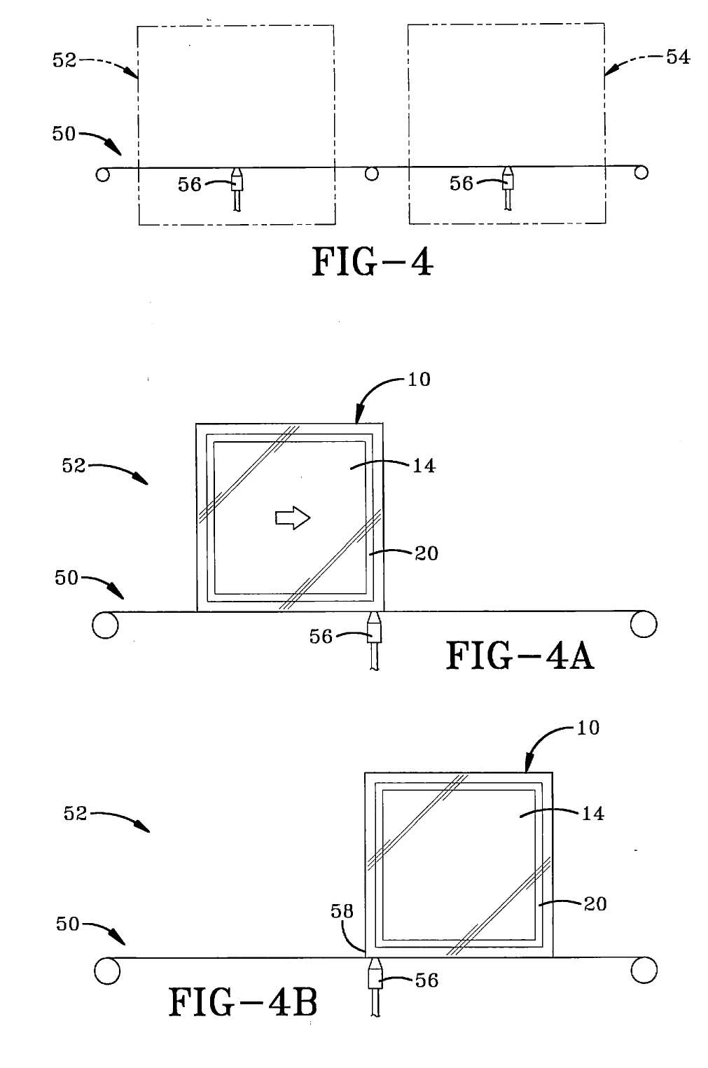

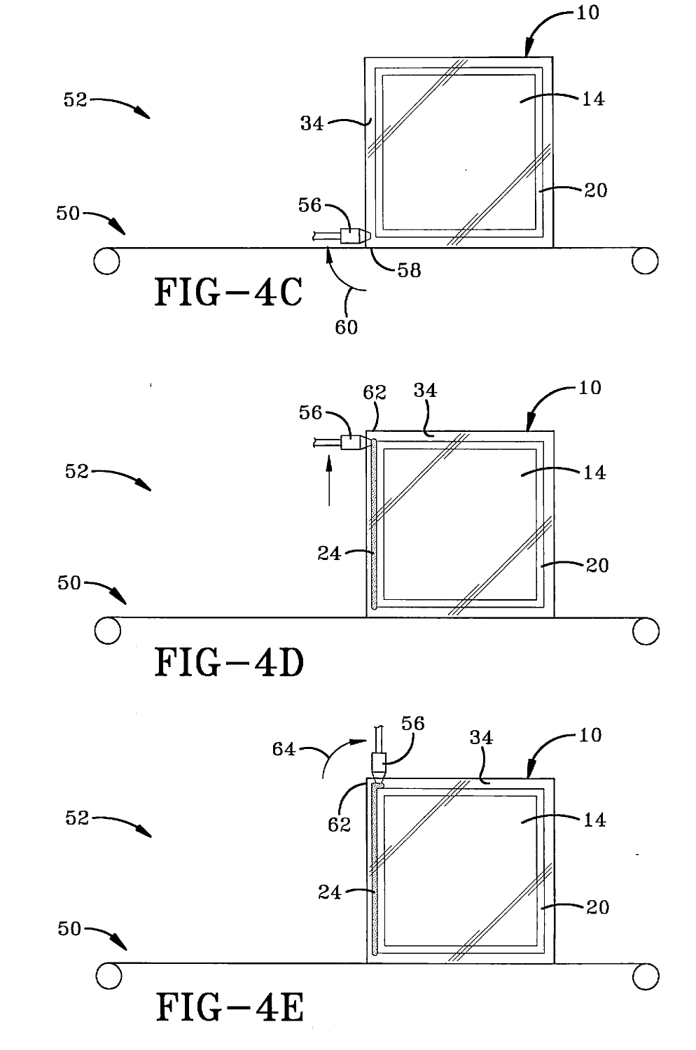

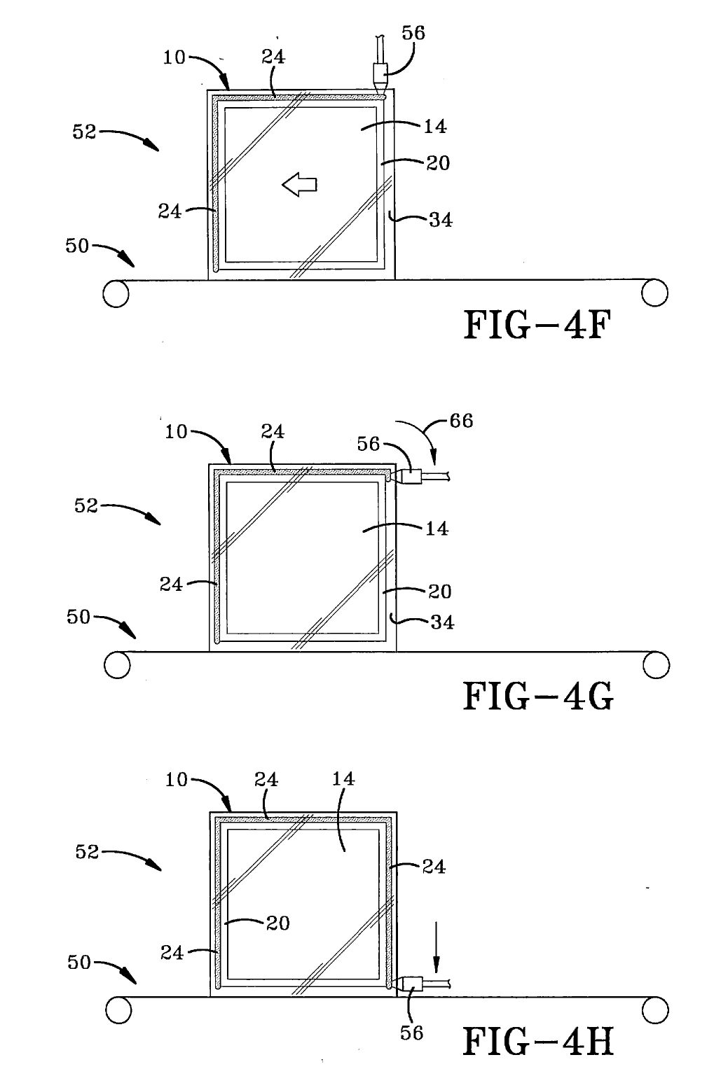

Sealants 24 and 26 may be applied to channel 34 with a variety of methods. A first method for applying sealants 24 and 26 into channel 34 is to provide an assembly line 50 (FIG. 4) wherein a first sealant application station 52 is disposed upstream of a second sealant application station 54. Primary sealant 24 is applied around the perimeter at the first sealant application station and secondary sealant 26 is applied over primary sealant 24 at the second sealant application station.

The assembled glazing sheets 14,16 and spacer 20 are delivered to first sealant application station 52 so that primary sealant 24 may be applied to hermetically seal insulating chamber 18. FIGS. 4A through 4J depict the steps for applying primary sealant 24. Glazing sheets 14,16 are passed over a first application nozzle 56 until the nozzle 56 reaches the lower rear corner 58 (FIG. 4B). Nozzle 56 is rotated upwardly as indicated by numeral 60 (FIG. 4C) and primary sealant 24 is applied into channel 34 into the corners of channel 34 or entirely across channel 34. Nozzle 56 moves up to the upper rear corner 62 (FIG. 4D) where it is rotated as indicated by the numeral 64 (FIG. 4E). Primary sealant 24 is applied to the corner as nozzle 56 rotates to insure that a proper seal is formed at the corner. Glazing sheets 14 and 16 are then moved rearwardly (FIG. 4F) so that primary sealant 24 is applied to the upper channel. Nozzle 56 is rotated downwardly (numeral 66, FIG. 4G) and moved downwardly (FIG. 4H) to apply the sealant to the third side of channel 34. Nozzle 56 is then moved back to its initial position (FIG. 4I) and glazing sheets 14,16 are moved forward (FIG. 4J) so that sealant 24 may be applied to the fourth side. Secondary sealant 26 is applied at second sealant application station 54 by the same process described above with respect to primary sealant 24.

The path followed by nozzle 56 along channel 34 may be any of the paths described below or any of the paths known to those skilled in the art.

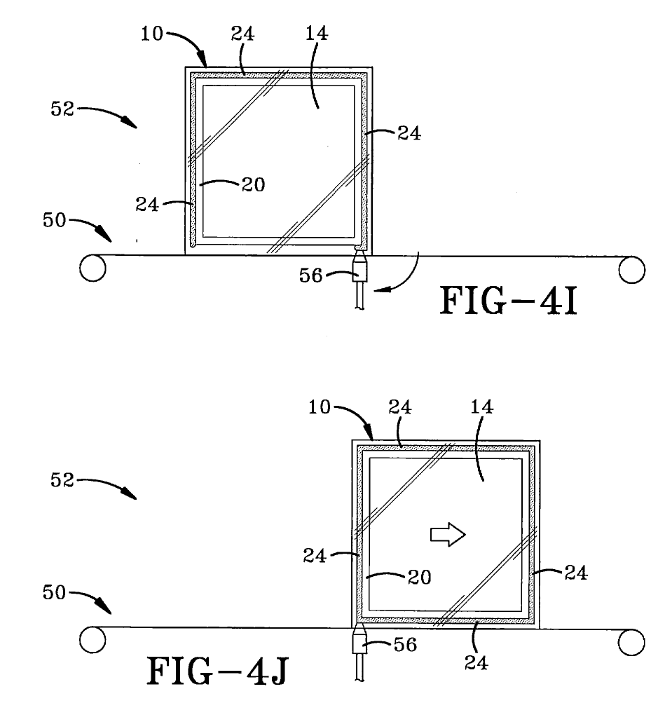

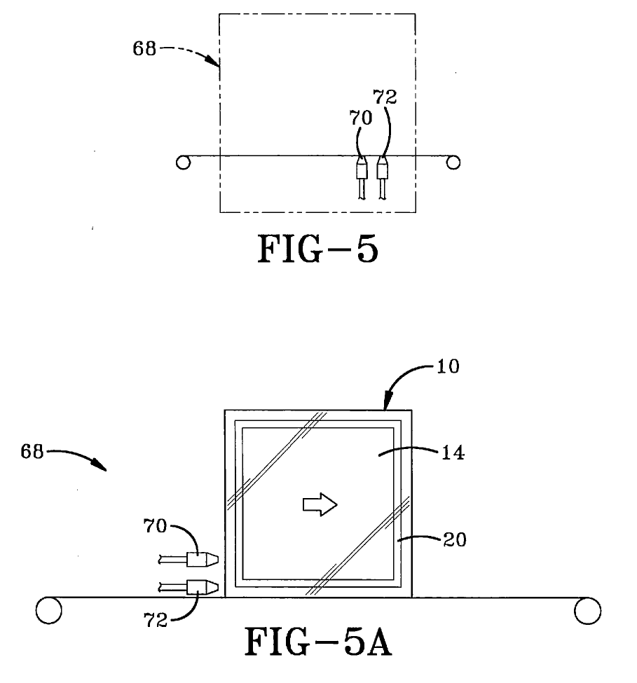

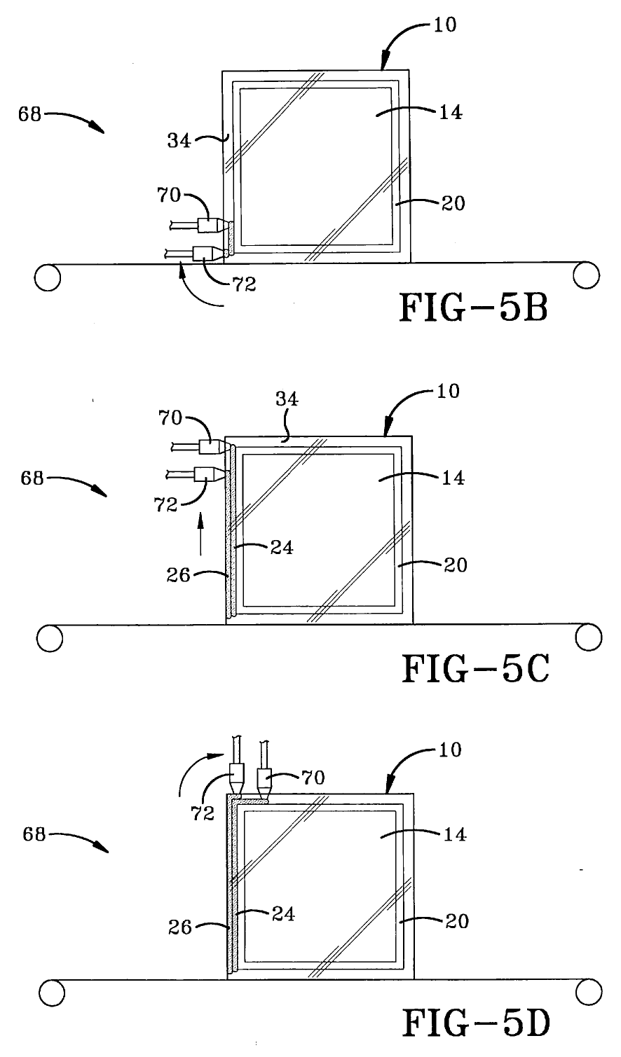

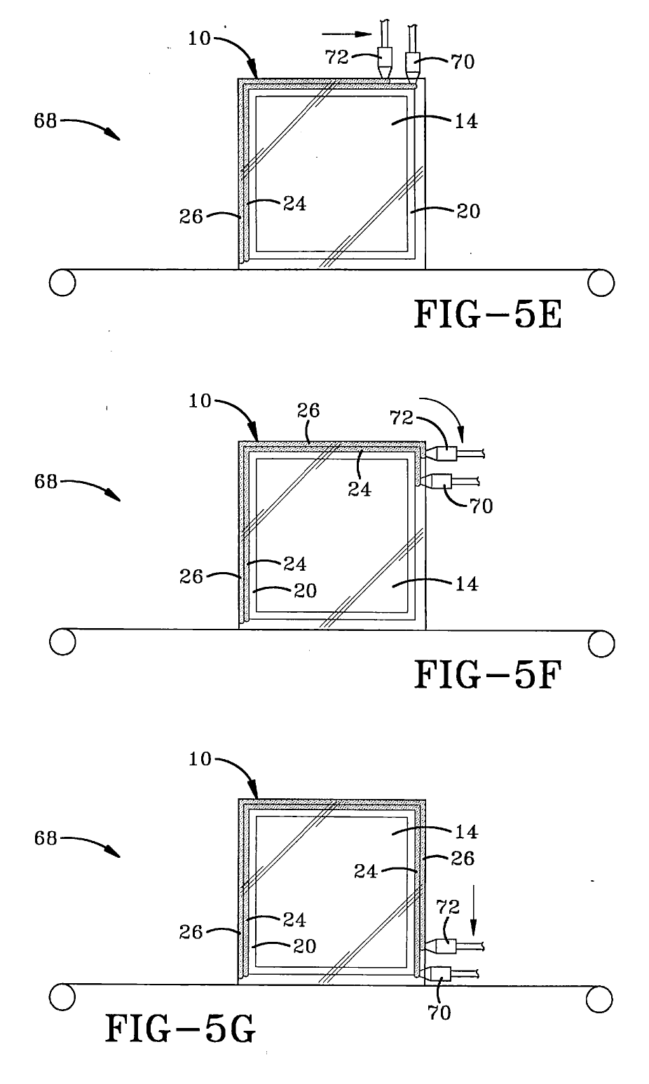

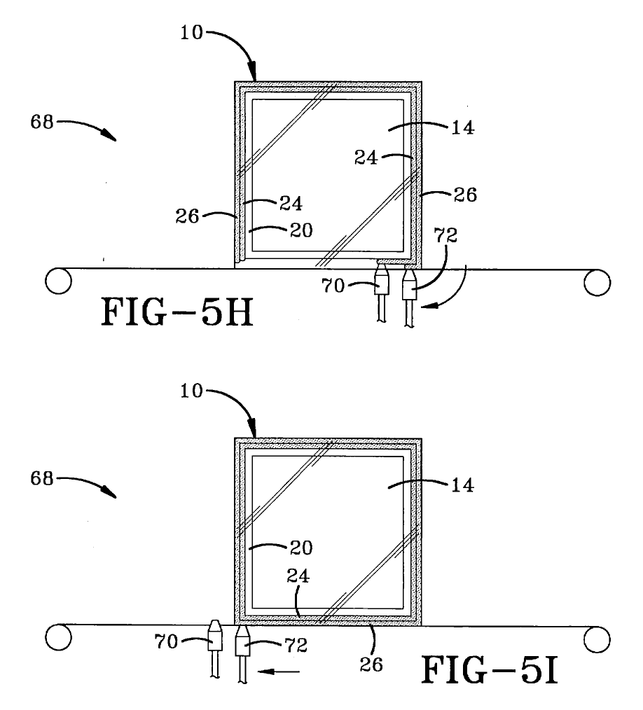

A second method for applying sealants 24 and 26 into channel 34 is to apply both sealants 24 and 26 around the perimeter at a single sealant application station 68 by moving two sealant application nozzles 70 and 72 around the perimeter (FIGS. 5A through 5I). Nozzles 70 and 72 are spaced apart so that primary sealant 24 is applied into channel 34 and secondary sealant 26 is applied over primary sealant 24 immediately after primary sealant 24 is applied. The first nozzle 70 may be extendable and retractable so that secondary sealant 26 may be applied entirely around the perimeter. In the embodiment of the invention depicted in the drawings, nozzles 70 and 72 do not have to retract because they start at a corner of unit 10. In other embodiments, nozzle 70 may retract so that it does not disturb secondary sealant 26.

The path followed by nozzles 70 and 72 may be the same path described above with respect to FIGS. 4A through 4J, may be either of the paths described below, or may be another path known in the art.

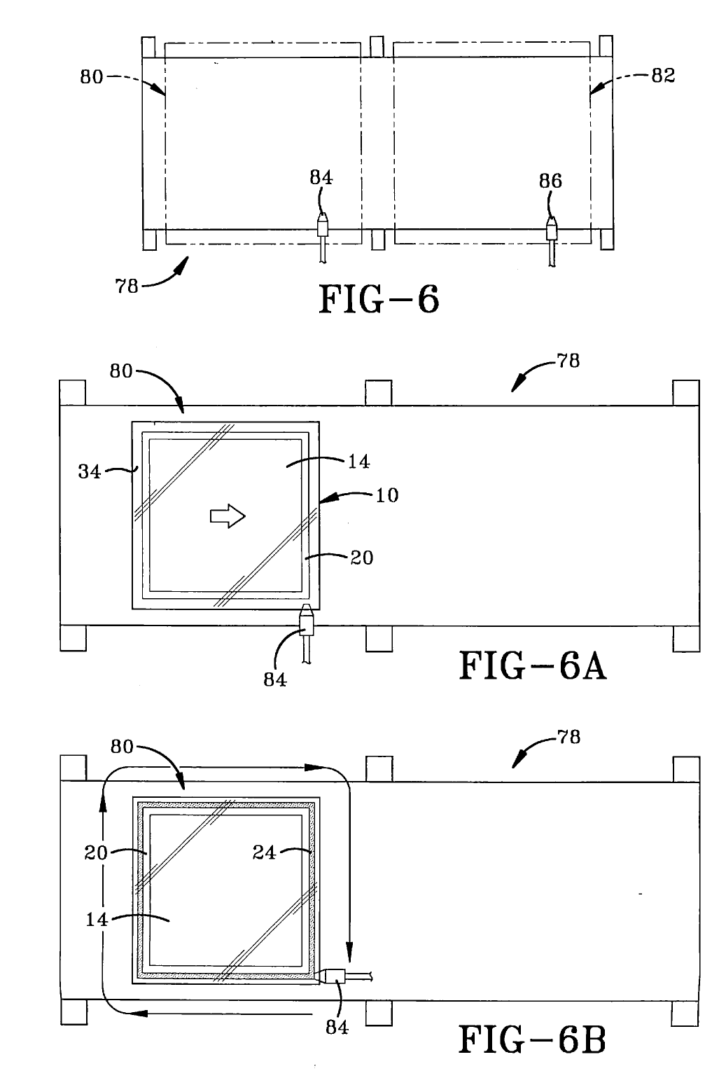

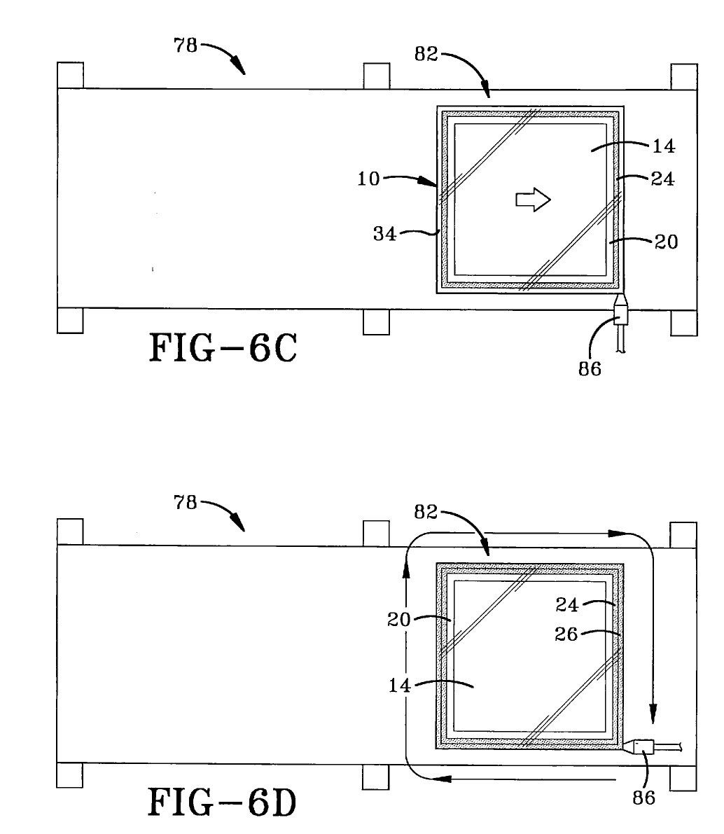

A third method for applying sealants 24 and 26 into channel 34 is depicted in FIGS. 6 through 6D. The assembly line 78 depicted in FIG. 6 includes first 80 and second 82 sealant application stations that each include a single nozzle 84 and 86. Nozzles 84 and 86 are configured to be moved entirely around the perimeter. In this embodiment of the method, glazing sheets 14,16 are horizontal. Again, the relative paths followed by nozzles 84 and 86 may be different than the paths shown in FIGS. 6B and 6D.

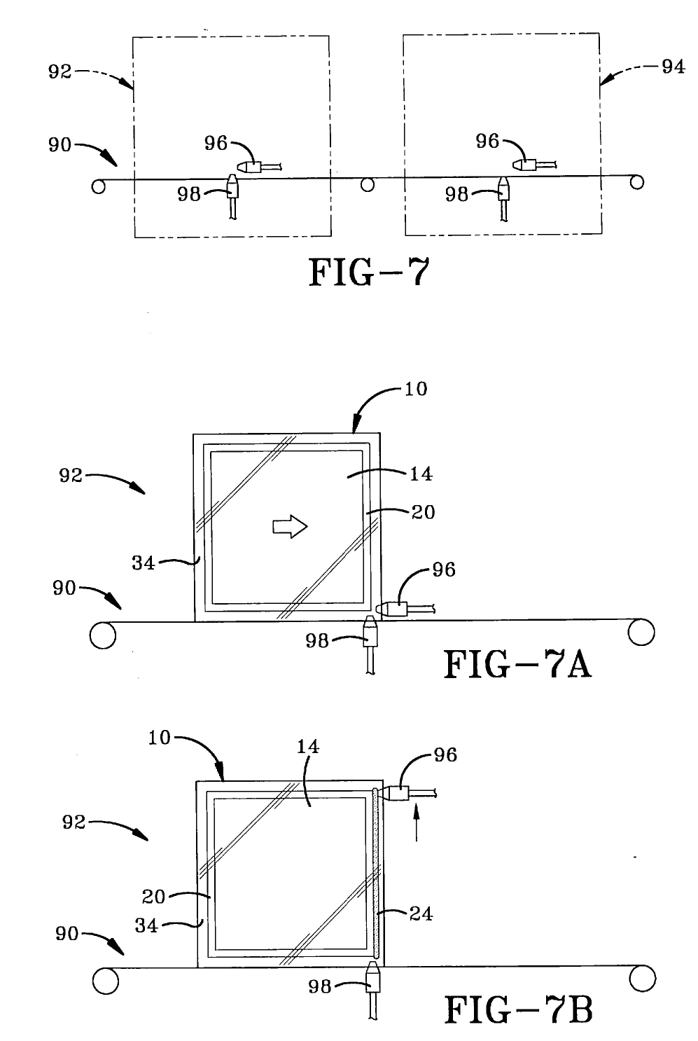

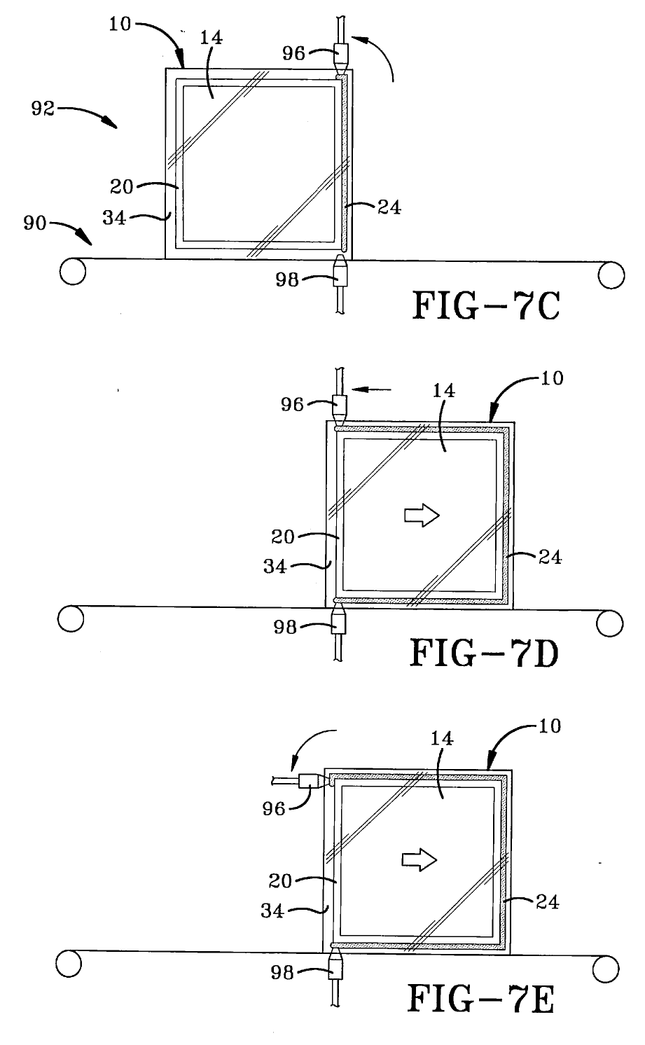

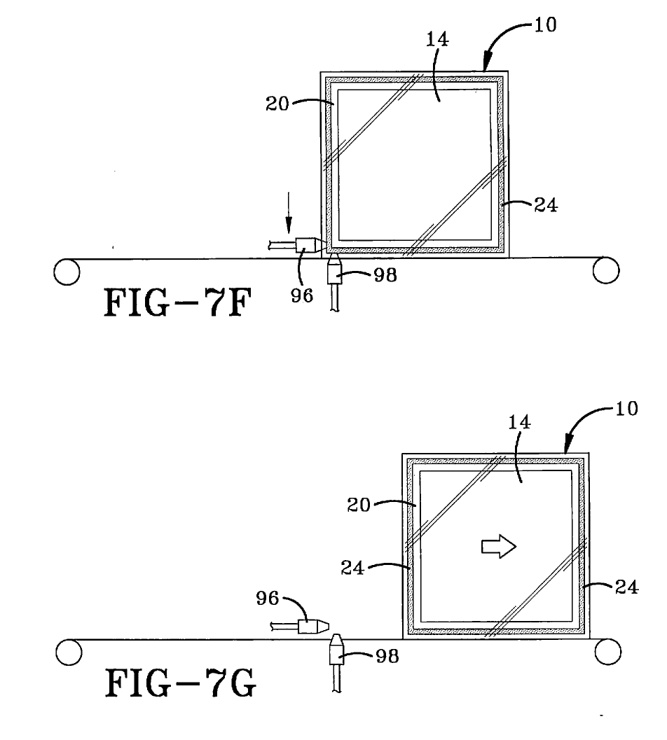

A fourth method for applying sealants 24 and 26 into channel 34 is depicted in FIGS. 7 through 7G. The assembly line 90 includes first 92 and second 94 sealant application stations with each having first and second sealant application nozzles 96 and 98. Glazing sheets 14,16 are moved into nozzles 96 and 98 until the lower right corner is positioned adjacent nozzles 96 and 98 (FIG. 7A). First nozzle 96 is moved up along a first side to apply primary sealant 24 to one side of channel 34 (FIG. 7B). Glazing sheets 14,16 are then moved forward and both nozzles 96 and 98 apply sealant to the opposed top and bottom sides simultaneously (FIG. 7D). Glazing sheets 14,16 are stopped and first nozzle 96 is moved down to complete the application (FIG. 7F). Secondary sealant 26 is applied with the same steps at second sealant application station 94.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method for fabricating an insulating glazing unit comprising the steps of:
providing a first glazing sheet having a first perimeter;
connecting a spacer to the first glazing sheet at a location spaced inwardly from the first perimeter;
providing a second glazing sheet having a second perimeter;
connecting the second glazing sheet to the spacer such that the spacer is disposed at a location inward from the second perimeter whereby an outwardly-facing channel is formed between the glazing sheets and the spacer and an insulating chamber is formed inward of the spacer between the glazing sheets;
hermetically sealing the insulating chamber by applying a primary sealant into the outwardly-facing channel; and
applying a secondary sealant into the outwardly-facing channel after at least a portion of the primary sealant is applied.

2. The method of claim 1, further comprising the step of providing a foam-bodied spacer carrying a desiccant.

3. The method of claim 2, further comprising the step of providing the spacer with a pair of notched corners.

4. The method of claim 3, further comprising the step of applying the primary sealant only into the notched corners of the spacer.

5. The method of claim 1, further comprising the step of providing a metal spacer.

6. The method of claim 4, further comprising the step of providing the spacer with a pair of notched corners.

7. The method of claim 6, further comprising the step of applying the primary sealant only into the notched corners of the spacer.

8. The method of claim 1, wherein the primary sealant is hot melt butyl.

9. The method of claim 1, wherein the primary sealant is polyisobutylene.

10. The method of claim 1, wherein the primary sealant is a curable low permeable sealant.

11. The method of claim 1, wherein the secondary sealant is a thermosetting sealant.

12. The method of claim 1, wherein the secondary sealant is a structural sealant.

13. The method of claim 12, wherein the secondary sealant is one of a silicone, a polysulfide, and a polyurethane.

14. The method of claim 1, wherein the primary sealant is applied to entire perimeter of the channel before the secondary sealant is applied.

15. The method of claim 14, wherein the primary sealant is applied at a first station with a first application nozzle and the secondary sealant is applied at a second station with a second application nozzle; the second station being spaced from the first station.

16. The method of claim 1, wherein the primary sealant is applied into the channel with a first applicator and the secondary sealant is applied with a second applicator that trails the first applicator.

17. The method of claim 16, further comprising the step of retracting the applicator that applies the primary sealant.

18. The method of claim 1, wherein the primary sealant is applied only to the corners of the channel adjacent the spacer and glazing sheets.

19. A method for sealing an insulating glazing unit having first and second glazing sheets spaced apart by a spacer disposed inward of the perimeters of the glazing sheets to form an outwardly-facing channel; the insulating glazing unit having an insulating chamber disposed inward of the spacer between the glazing sheets; the method comprising the steps of:
hermetically sealing the insulating chamber by applying a primary sealant to at least the corners of the channel disposed adjacent the spacer and glazing sheets; and
applying a secondary sealant in the outwardly-facing channel over the primary sealant; the secondary sealant being different from the primary sealant.

20. The method of claim 19, wherein the primary sealant is hot melt butyl.

21. The method of claim 19, wherein the primary sealant is polyisobutylene.

22. The method of claim 19, wherein the secondary sealant is a structural sealant.

23. The method of claim 19, wherein the secondary sealant is a thermosetting sealant.

24. The method of claim 19, wherein the primary sealant is applied only in the corners adjacent the spacer and the glazing sheets.

25. The method of claim 19, wherein the insulating chamber is hermetically sealed by simultaneously applying the primary sealant to the glazing sheets and the spacer.

26. A method of forming an insulating glazing unit comprising the steps of:
providing a first glazing sheet having a first perimeter;
connecting a metal spacer to the first glazing sheet at a location spaced inwardly from the first perimeter;
providing a second glazing sheet having a second perimeter;
connecting the second glazing sheet to the spacer such that the spacer is disposed at a location inwardly from the second perimeter whereby an outwardly-facing channel is formed between the glazing sheets and the spacer and an insulating chamber is formed inwardly of the spacer between the glazing sheets;
applying a primary sealant into the outwardly-facing channel to hermetically seal the insulating chamber; and
applying a secondary sealant over the primary sealant.

27. The method of claim 26, wherein the metal spacer is free of sealant when it is connected to the first and second glazing sheets.

28. The method of claim 26, wherein the secondary sealant is a structural sealant.

29. The method of claim 26, wherein the primary sealant is disposed in the corners between the glazing sheets and the metal spacer.
